(19) United States
(12) Patent Application Publication
(10) Pub. No.: US 2024/0338894 A1
(43) Pub. Date: Oct. 10, 2024

(54) VIRTUAL OBJECT DISPLAY METHOD AND APPARATUS, TERMINAL DEVICE, AND STORAGE MEDIUM

(71) Applicant: Tencent Technology (Shenzhen) Company Limited, Shenzhen (CN)

(72) Inventors: Xiaofeng CHEN, Shenzhen (CN); Yuanyuan PEI, Shenzhen (CN); Yun AI, Shenzhen (CN); Xingqi ZHOU, Shenzhen (CN)

(21) Appl. No.: 18/747,290

(22) Filed: Jun. 18, 2024

Related U.S. Application Data
(63) Continuation of application No. PCT/CN2023/091373, filed on Apr. 27, 2023.

(30) Foreign Application Priority Data
Jul. 8, 2022 (CN) 202210805805.8

(51) Int. Cl. G06T 17/20; G06T 7/70

(52) U.S. Cl. CPC G06T 17/20; G06T 7/70

(57) ABSTRACT

The present disclosure discloses a virtual object display method performed by a computer device. The method includes: determining an interception plane of a three-dimensional model of a first virtual object; acquiring posture information of the three-dimensional model once after a preset time period; intercepting the three-dimensional model by using the interception plane based on the posture information to obtain an interception result, wherein the interception result comprises a partial model of the three-dimensional model located on a first side of the interception plane; and displaying the partial model on the first side. According to the technical solution provided in embodiments of this application, the model part on the first side corresponding to the three-dimensional model is displayed, so that efficiency of acquiring model information and interface utilization can be improved.

### CROSS-REFERENCE TO RELATED APPLICATIONS

This application is a continuation application of PCT Patent Application No. PCT/CN2023/091373, entitled “VIRTUAL OBJECT DISPLAY METHOD AND APPARATUS, TERMINAL DEVICE, AND STORAGE MEDIUM” filed on Apr. 27, 2023, which claims priority to Chinese Patent Application No. 202210805805.8, entitled “VIRTUAL OBJECT DISPLAY METHOD AND APPARATUS, TERMINAL DEVICE, AND STORAGE MEDIUM” filed on Jul. 8, 2022, both of which are incorporated by reference in their entirety.

### FIELD OF THE TECHNOLOGY

Embodiments of this application relate to the technical field of application development, and in particular, to a virtual object display method and apparatus, a terminal device, and a storage medium.

### BACKGROUND OF THE DISCLOSURE

In some game scenes, a client needs to display some virtual objects related to the game scenes, for example, non-player characters (NPCs) related to the game scenes.

In the related art, the client can only statically display a complete model of the virtual object. The complete model in this display mode occupies a large display area, resulting in low interface utilization.

### SUMMARY

Embodiments of this application provide a virtual object display method and apparatus, a terminal device, and a storage medium, which can improve effectiveness of displaying virtual objects. The technical solutions are as follows:

According to one aspect of the embodiments of this application, a virtual object display method is performed by a terminal device, the method including:
determining an interception plane of a three-dimensional model of a first virtual object;
acquiring posture information of the three-dimensional model once after a preset time period;
intercepting the three-dimensional model by using the interception plane based on the posture information to obtain an interception result, wherein the interception result comprises a partial model of the three-dimensional model located on a first side of the interception plane; and
displaying the partial model on the first side.

According to one aspect of the embodiments of this application, provided is a computer device, including a processor and a memory. The memory has a computer program stored therein. The computer program is loaded and executed by the processor to implement the above virtual object display method.

According to one aspect of the embodiments of this application, provided is a non-transitory computer-readable storage medium, having a computer program stored therein. The computer program is loaded and executed by a processor of a computer device to implement the above virtual object display method.

The technical solutions provided in the embodiments of this application can include the following beneficial effects:
the three-dimensional model of the first virtual object is intercepted by the interception plane, the interception result is displayed (namely, the partial model on the first side), and because the three-dimensional model is displayed after being intercepted and only the partial model on the first side of the interception plane is displayed, a more focused display of the model of the first virtual object can be achieved. The user only needs to acquire the information related to the first virtual object from the partial model on the first side without being affected by model parts useless for the user (for example, the user cannot obtain useful information from the model part), which helps the user rapidly and conveniently acquire the model information, improving efficiency of acquiring the model information. In addition, displaying only a part of the three-dimensional model is beneficial to reduction of the display area occupied by the model, such that other areas in the interface can display more contents, thereby improving interface utilization.

The foregoing general descriptions and the following detailed descriptions are merely for illustration and explanation purposes and are not intended to limit this application.

### BRIEF DESCRIPTION OF THE DRAWINGS

FIG. 1 is a schematic diagram of an implementation environment according to an embodiment of this application.

FIG. 2 is a schematic diagram of a virtual object display method according to an embodiment of this application.

FIG. 3 is a flowchart of a virtual object display method according to an embodiment of this application.

FIG. 4 is a schematic diagram of virtual object display according to an embodiment of this application.

FIG. 5 is a schematic diagram of virtual object display according to another embodiment of this application.

FIG. 6 is a flowchart of a virtual object display method according to another embodiment of this application.

FIG. 7 is a schematic diagram of an interface according to an embodiment of this application.

FIG. 8 is a flowchart of a method for adjusting a display layout according to an embodiment of this application.

FIG. 9 is a flowchart of a virtual object control method according to an embodiment of this application.

FIG. 10 is a flowchart of a virtual object display method according to another embodiment of this application.

FIG. 11 is a flowchart of a virtual object display method according to another embodiment of this application.

FIG. 12 is a block diagram of a virtual object display apparatus according to an embodiment of this application.

FIG. 13 is a block diagram of a virtual object display apparatus according to another embodiment of this application.

FIG. 14 is a block diagram of a virtual object display apparatus according to another embodiment of this application.

FIG. 15 is a block diagram of a terminal device according to an embodiment of this application.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. Implementations described in the following exemplary embodiments do not represent all implementations consistent with this application. On the contrary, the implementations are merely examples of methods that are described in detail in the appended claims and are consistent with some aspects of this application.

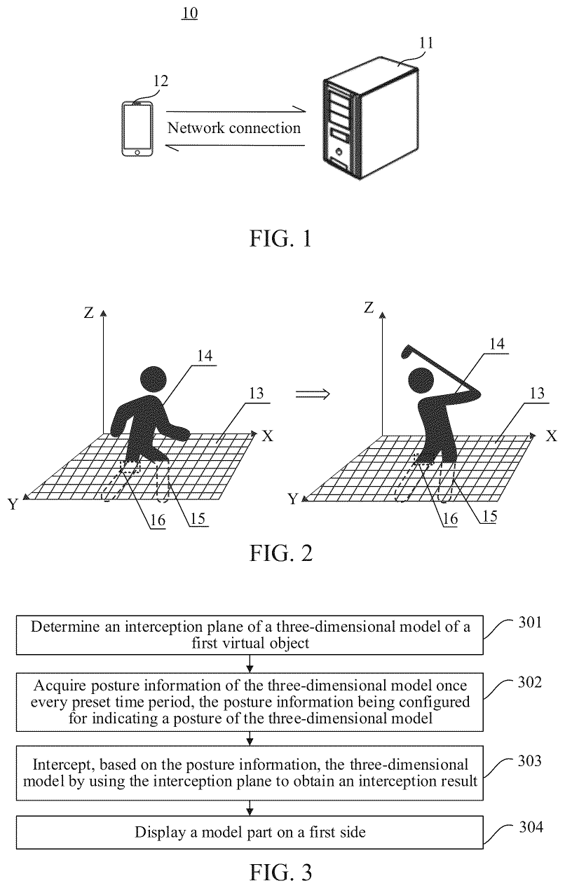

FIG. 1 is a schematic diagram of an implementation environment according to an embodiment of this application. The implementation environment may be implemented as a virtual object display system 10. The system 10 may include a terminal device 11.

A target application, for example, a client of the target application, is installed and runs in the terminal device 11, and a user account is logged in to the client. The terminal device 11 refers to an electronic device with data calculation, processing, and storage capabilities. For example, the terminal device 11 may be a smart phone, a tablet computer, a personal computer (PC), a wearable device, a vehicle-mounted terminal, or an intelligent robot. This is not limited in embodiments of this application. In some embodiments, the terminal device 11 is a mobile terminal device with a touch screen, and a user can achieve human-computer interaction through the touch screen. The target application may be a game application, for example, a shooting game application, a multiplayer battle survival game application, a battle royale survival game application, a location based service (LBS) game application, or a multiplayer online battle arena (MOBA) game application. This is not limited in embodiments of this application. The target application may alternatively be any application with a virtual object display function, for example a social application, a payment application, a video application, a music application, a shopping application, or a news application. Each operation of the method provided in embodiments of this application may be performed by the terminal device 11, for example, the client running in the terminal device 11.

In some embodiments, the client may display the virtual object in a virtual environment. The virtual environment is a scene displayed (or provided) when the client of the target application (for example, the game application) runs in the terminal device. The virtual environment refers to a scene constructed for the virtual object to engage in activities (for example, game competitions), for example, a virtual house, a virtual island, or a virtual map. The virtual environment may be a simulated environment of the real world, a semi-simulated and semi-fictional environment, or a purely fictional environment. The virtual environment may be a two-dimensional virtual environment, a 2.5-dimensional virtual environment, or a three-dimensional virtual environment. This is not limited in embodiments of this application.

The virtual object refers to a virtual character controlled by the user account in the target application. That the target application is the game application is used as an example. The virtual object refers to a game character controlled by the user account in the game application. The virtual object may be in a form of a character, a form of an animal, a form of a cartoon, or another form. This is not limited in embodiments of this application. The virtual object may be displayed in a three-dimensional form. In some embodiments, when the virtual environment is the three-dimensional virtual environment, the virtual object may be a three-dimensional model created based on an animation bone technology. The virtual object has a shape and a volume in the three-dimensional virtual environment, and occupies a portion of space in the three-dimensional virtual environment. In some embodiments, the target application may have a function of simulating a real physical environment. In the virtual environment, a motion law of each virtual element (for example, the virtual object) conforms to or is close to a real physical law.

In some embodiments, the system 10 further includes a server 12. The server 12 establishes a communication connection (for example, a network connection) to the terminal device 11. The server 12 is configured to provide a background service for the target application. The server 12 may be an independent physical server, a server cluster or a distributed system including a plurality of physical servers, or a cloud server providing a cloud computing service.

A virtual object display method provided in embodiments of this application may be applied to a scene in which a display screen is used for display, or may be applied to display scenes such as augmented reality (AR) and virtual reality (VR). This is not specifically limited in embodiments of this application.

For example, as shown in FIG. 2, the virtual object display method may include: determining an interception plane 13 corresponding to a three-dimensional model of a first virtual object; determining, upon reaching display time, a partial model 14 that is of the three-dimensional model and that is located on an upper side of the interception plane and a partial model 15 that is of the three-dimensional model and that is located on a lower side of the interception plane; and displaying the partial model 14 that is of the three-dimensional model and that is located on the upper side of the interception plane and hiding the partial model 15 that is of the three-dimensional model and that is located on the lower side of the interception plane.

In some embodiments, the interception plane corresponding to the three-dimensional model of the first virtual object is a fixed plane. When a posture of the first virtual object changes, the partial model that is of the three-dimensional model and that is located on the upper side of the interception plane also changes. For example, a part 16 that is of the three-dimensional model and that is originally located on the lower side of the interception plane 13 is not displayed, and due to the posture change of the three-dimensional model, after the part 16 moves to the upper side of the interception plane 13, the part 16 is displayed again.

The following describes the technical solution provided in embodiments of this application by using several embodiments.

FIG. 3 is a flowchart of a virtual object display method according to an embodiment of this application. In this embodiment, that the method is applied to the client introduced above is used as an example for description. The method may include the following operations (301 to 304):

Operation 301: Determine an interception plane of a three-dimensional model of a first virtual object.

The first virtual object may refer to a virtual object provided by the foregoing target application (for example, a game application). In this embodiment of this application, the first virtual object may be referred to as a target virtual object, to indicate any virtual object with a three-dimensional model that needs to be displayed. In some embodiments, the first virtual object is displayed in a form of the three-dimensional model.

In some embodiments, the interception plane is a fixed plane, and the interception plane is not actually displayed, and is merely a theoretical plane configured to intercept the three-dimensional model of the first virtual object. The interception plane can be configured to divide the three-dimensional model. In some embodiments, a rectangular plane coordinate system (namely, a Euclidean coordinate system) corresponding to the first virtual object is established, where the rectangular plane coordinate system includes three mutually perpendicular axes: an X-axis, a Y-axis, and a Z-axis, and a plane formed by two of the three axes is the interception plane. For example, the interception plane is a plane including the X-axis and the Y-axis. Values respectively corresponding to the X-axis and the Y-axis may be set according to an actual usage requirement. For example, the interception plane is a plane with z=1.

In some embodiments, the interception plane is parallel to a ground surface of a virtual environment where the first virtual object is located; or the interception plane is parallel to a horizontal plane of a virtual environment where the first virtual object is located.

In some embodiments, determining the interception plane of the three-dimensional model of the first virtual object includes at least one of the following determination mode 1 and second determination mode 2.

Determination mode 1: Determine the interception plane based on a battle situation of the first virtual object or the virtual environment where the first virtual object is located.

In some embodiments, the first virtual object is located in the virtual environment (for example, a virtual environment in a game) and engages in battle with another virtual object in the virtual environment. The battle situation may refer to progress of the battle. For example, the battle situation of the first virtual object may be an interaction situation between the first virtual object and the another virtual object. The interception plane corresponding to the first virtual object may vary with different battle situations or virtual environments where the first virtual object is located. The another virtual object may be a virtual object other than the first virtual object in the virtual environment.

In some embodiments, determining the interception plane based on the battle situation of the first virtual object or the virtual environment where the first virtual object is located includes at least one of the following cases:

(1) When the first virtual object is under attack, the interception plane is adjusted to prominently display an attacked part of the first virtual object.

In some embodiments, the first virtual object is attacked during the battle. If based on a current position of the interception plane, the attacked part of the first virtual object is not displayed (for example, the attacked part of the first virtual object is located on a lower side of the interception plane), the interception plane may be adjusted (for example, the position of the interception plane is moved downwards to a position below the attacked part) to display the attacked part of the first virtual object. Alternatively, in some embodiments, the position of the interception plane is adjusted, so that the interception plane is moved to a position near the attacked part of the first virtual object, to prominently display the attacked part of the first virtual object.

That the interception plane is parallel to the horizontal plane of the virtual environment is used as an example. For example, the current interception plane is near the knee of the first virtual object, and if the calf of the first virtual object is attacked, the interception plane maybe moved to the ankle of the first virtual object, to display the calf of the first virtual object. For another example, the current interception plane is near the knee of the first virtual object, and if the head of the first virtual object is attacked, the interception plane maybe moved to the shoulder or neck of the first virtual object, to prominently display the attacked head of the first virtual object.

(2) When the first virtual object performs an attack operation or a defensive operation, the interception plane is adjusted to prominently display a part that is of the first virtual object and that performs the attack operation or the defensive operation.

In some embodiments, the first virtual object performs the attack operation or the defensive operation during the battle. If based on a current position of the interception plane, the corresponding part that is of the first virtual object and that performs the attack operation or the defensive operation is not displayed (for example, the part is located on a lower side of the interception plane), the interception plane maybe adjusted (for example, the interception plane is moved downwards), to display the corresponding part that performs the attack operation or the defensive operation. Alternatively, in some embodiments, the position of the interception plane is adjusted, so that the interception plane is moved to a position near the corresponding part that is of the first virtual object and that performs the attack operation or the defensive operation, to prominently display the part that is of the first virtual object and that performs the attack operation or the defensive operation.

That the interception plane is parallel to the horizontal plane of the virtual environment is used as an example. For example, the current interception plane is near the hip of the first virtual object, and if the first virtual object performs the attack operation or the defensive operation through the knee, the interception plane maybe moved to the calf of the first virtual object, to display the knee part of the first virtual object. For another example, the current interception plane is near the knee of the first virtual object, and if the first virtual object performs the attack operation or the defensive operation through the upper body, the interception plane maybe moved upwards to the waist of the first virtual object, to prominently display the part that is of the first virtual object and that performs the attack operation or the defensive operation. In this way, a user can acquire information more intuitively and effectively. A partial model corresponding to information useless to the user does not need to be displayed, thereby improving efficiency of obtaining model information by the user.

In some embodiments, equipment of the first virtual object may be prominently displayed to facilitate another user in acquiring equipment information of the first virtual object. For example, if attack equipment or defensive equipment of the first virtual object is carried on the back or placed in a backpack, the interception plane is near the knee of the first virtual object; if the first virtual object holds attack equipment or defensive equipment in hand, the interception plane may be moved upwards (for example, moved upwards to the hip or waist of the first virtual object); or if the first virtual object places attack equipment or defensive equipment in front of the body, the interception plane may be further moved upwards. In some embodiments, if a dangerous part of the equipment (for example, a muzzle of a gun) of the first virtual object changes from pointing downward to pointing forward, the interception plane is moved upwards; or if a dangerous part of the equipment of the first virtual object changes from pointing forward to pointing downward, the interception plane is moved downwards.

(3) The interception plane is determined based on a vegetation type, a weather condition, or a terrain of the virtual environment.

In some embodiments, if the ground surface of the virtual environment has dense vegetation or other obstructions, the interception plane is higher than these vegetation or obstructions. For example, if the virtual environment is a lush grassland with herbaceous plants, and the herbaceous plants on the ground surface generally reach the knee height of the first virtual object, the interception plane is near or above the knee of the three-dimensional model of the first virtual object. For another example, if the virtual environment is a dense shrubbery with shrub plants, and shrub plants on the ground surface generally reach the waist height of the first virtual object, the interception plane is near or above the waist of the three-dimensional model of the first virtual object.

In some embodiments, different ground surface terrains in the virtual environment cause different levels of obstruction to the three-dimensional model of the first virtual object. For example, if the ground surface of the virtual environment is covered by the water (for example, a swamp), a height of the interception plane is greater than or equal to a water level height of the water. For another example, the virtual environment is the desert, where land vegetation is sparse on a ground surface of the desert, the interception plane may be located at the ankle, knee, waist, or the like of the three-dimensional model of the first virtual object.

In some embodiments, the position of the interception plane can be determined based on weather conditions in the virtual environment. For example, on a sunny day in the virtual environment, the lighting conditions of the entire virtual environment are good, the three-dimensional model of the first virtual object is relatively clear, and therefore the position of the corresponding interception plane may be low (for example, located at the knee of the three-dimensional model of the first virtual object) to display more model parts of the three-dimensional model; and for another example, on a cloudy or rainy day in the virtual environment, the light is dim in the entire virtual environment, and therefore the position of the interception plane corresponding to the cloudy or rainy day may be moved upwards relative to the position of the interception plane corresponding to the sunny day (for example, being adjusted to the hip or waist of the three-dimensional model of the first virtual object), to focus on the display (or highlight the display) of the upper body of the three-dimensional model of the first virtual object.

According to the determination mode 1, the interception plane is dynamically adjusted in a targeted mode based on the corresponding battle situation or virtual environment of the first virtual object, thereby improving the flexibility of model display, prominently displaying the model parts related to the battle situation or virtual environment, allowing the user to quickly and conveniently acquire relevant information without being affected by model parts with no useful information, and further improving effectiveness of model display.

Determination mode 2: Determine the interception plane of the three-dimensional model of the first virtual object in response to an interception plane setting operation for the first virtual object.

In some embodiments, the position of the interception plane may be set by the corresponding user of the client. For example, before or during a battle, the user may set the position of the interception plane of the first virtual object through game settings. The first virtual object may be a virtual object controlled by the user, or a virtual object controlled by other users, or a virtual object controlled by a non-user. This is not limited in embodiments of this application

In some embodiments, the determination mode 1 and the determination mode 2 may be alternatively executed or combined. For example, the target application may determine the interception plane based on the battle situation of the first virtual object or the virtual environment where the first virtual object is located. The user may automatically adjust the position of the interception plane based on that.

In some embodiments, the first virtual object may be a virtual object performing well in historical battles (for example, defeating a large number of virtual objects, and surviving for a long time).

Operation 302: Acquire posture information of the three-dimensional model once after a preset time period, where the posture information is configured for indicating a posture of the three-dimensional model.

In the embodiments of this application, the posture of the three-dimensional model is dynamically changed. For example, the posture of the three-dimensional model may change with the progress of the battle. In some embodiments, the first virtual object is a virtual character, and has a three-dimensional model being a human three-dimensional model. The posture of the three-dimensional model may be personified, meaning that the posture of the three-dimensional model can change like a person. Therefore, the client can acquire the posture information of the three-dimensional model once after a preset time period so as to dynamically update the three-dimensional model in real time. The preset time period may refer to a period of time preset according to actual usage requirements. In some embodiments, the cycle for acquiring the posture information of the three-dimensional model may be 0.008 s, 0.01 s, 0.05 s, or 0.1 s. This is not specifically limited in embodiments of this application.

Operation 303: Intercept, based on the posture information, the three-dimensional model by using the interception plane to obtain an interception result.

In some embodiments, the client determines, based on the posture information, the posture of the three-dimensional model in the virtual environment in real time, and then intercepts the three-dimensional model in the posture by using the interception plane, and therefore the interception result can be updated in real time. The interception result includes a partial model partial model of the three-dimensional model located on a first side of the interception plane, and the partial model on the first side changes with the posture of the three-dimensional model.

In some embodiments, the interception plane may divide the three-dimensional model into two parts: a partial model located on a first side of the interception plane, and a partial model located on a second side of the interception plane. The first side and the second side are two sides of the interception plane. For example, the first side may be configured to identify a partial model of the three-dimensional model to be displayed, and the second side may be configured to identify a partial model of the three-dimensional model not to be displayed. Which side of the interception plane the first side specifically refers to may be set and adjusted according to actual usage requirements. For example, taking the interception plane being parallel to the horizontal plane of the virtual environment as an example, if the first side is the upper side of the interception plane, the second side is the lower side of the interception plane; and if the first side is the lower side of the interception plane, the second side is the upper side of the interception plane.

In some embodiments, due to changes in the posture of the three-dimensional model, the partial model on the first side is not changeless but changes with the posture of the three-dimensional model. For example, certain model parts of the three-dimensional model may be located on the first side of the interception plane during one period and may be located on the second side of the interception plane during the other period. The posture of the partial model on the first side is consistent with the posture of the corresponding part of the three-dimensional model.

Operation 304: Display the partial model on the first side.

In some embodiments, the client displays, through the display screen, the partial model on the first side in a user interface. In some embodiments, after the interception result is determined, the client only displays the partial model on the first side, while the model parts of the three-dimensional model that do not belong to the first side are not displayed, namely, the partial model on the second side is hidden, thereby highlighting the partial model on the first side.

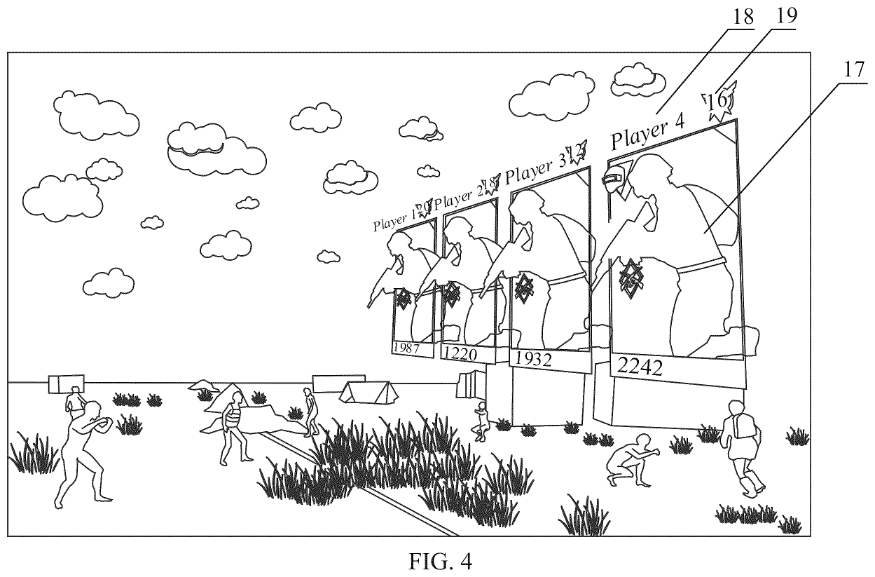

In some embodiments, as shown in FIG. 4, if the game scene requires projecting the three-dimensional model of the first virtual object to a designated position for display, the partial model 17 on the first side may be a projection of the first virtual object displayed in the virtual environment. In some embodiments, the client may further display information about the first virtual object while displaying the partial model on the first side. In some embodiments, near the display position of the partial model on the first side, an identify document (ID) and achievement information of the first virtual object are also displayed. As shown in FIG. 4, an ID 18 of the first virtual object and a number 19 of virtual objects defeated in past battles are further displayed near the partial model 17 on the first side.

In some embodiments, the client displays the partial model on the first side, and also displays the virtual environment where the first virtual object is located at present or a current position of the first virtual object (for example, a first position where the first virtual object is located).

In some embodiments, the partial model on the first side may be displayed during an actual battle. For example, during the battle of the first virtual object, the partial model on the first side is displayed at the designated position of the virtual environment, and or may be displayed in a preparation process before the battle (for example, in a b island where the virtual object is located before the battle starts). For example, based on the posture information of the first virtual object from the previous battle, the partial model on the first side is displayed at a designated position on the spawn island.

The above interception process is merely a selection process about which model parts of the three-dimensional model need to be displayed and which model parts are not displayed, rather than actually cutting off the partial model on the second side of the three-dimensional model. The model parts of the three-dimensional model that are not displayed are only temporarily hidden (namely, invisible to the user) and not rendered for display. After the hidden model parts move to the first side of the interception plane, the hidden model parts are displayed again. Therefore, by using just one three-dimensional model, the model parts on the first side corresponding to different interception results can be displayed, eliminating the need to separately fabricate intercepted models for different postures of the first virtual object, thereby reducing the model fabrication cost and model display cost.

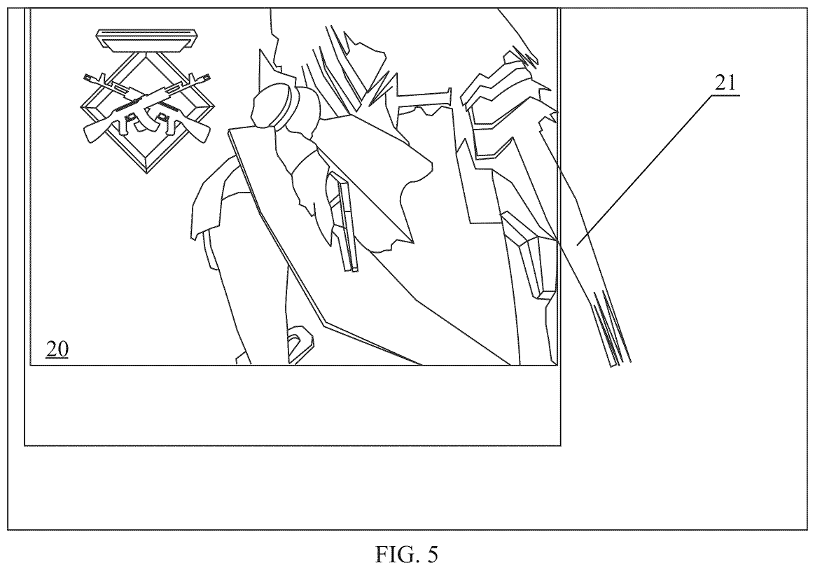

In some embodiments, the three-dimensional model of the first virtual object is intercepted by an interception frame. As shown in FIG. 5, the part of the three-dimensional model within an interception area 20 of the interception frame is rendered and displayed. The partial model 21 outside the interception area 20 is only temporarily hidden (namely, invisible to the user) and not rendered for display. After the hidden partial model 21 moves into the interception area 20, the hidden partial model 21 is displayed again.

In summary, according to the technical solution provided in the embodiments of this application, the three-dimensional model of the first virtual object is intercepted by the interception plane, the interception result is displayed (namely, the partial model on the first side), and because the three-dimensional model is displayed after being intercepted and only the partial model on the first side of the interception plane is displayed, a more focused display of the model of the first virtual object can be achieved. The user only needs to acquire the information related to the first virtual object from the partial model on the first side without being affected by model parts useless for the user (for example, the user cannot obtain useful information from the model part), which helps the user rapidly and conveniently acquire the model information, improving the efficiency of acquiring the model information. In addition, displaying only a part of the three-dimensional model is beneficial to reduction of the display area occupied by the model, such that other areas in the interface can display more contents, thereby improving the interface utilization.

In addition, when the posture of the three-dimensional model changes, the partial model on the first side changes as well, such that the partial model on the first side is displayed in a dynamic display mode rather than being limited to a fixed posture to be displayed, such that the user can acquire more information related to the first virtual object based on the partial model on the first side, thereby improving the display comprehensiveness of the model information and the richness of model information acquisition.

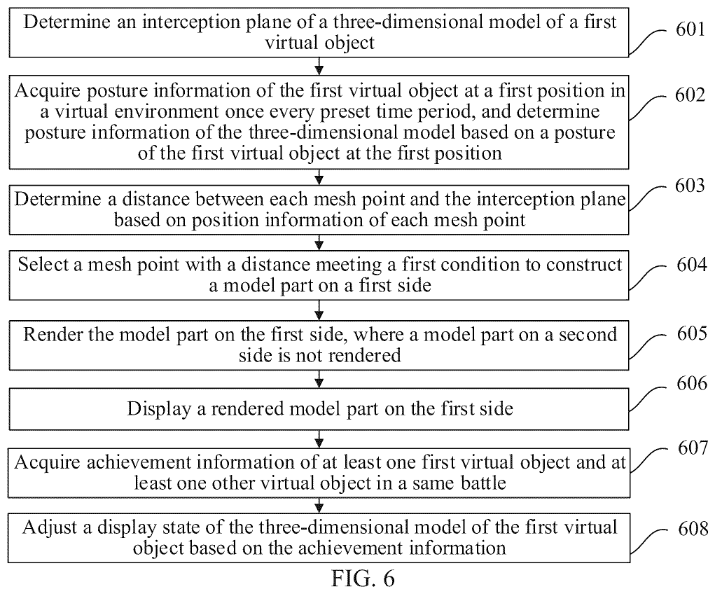

FIG. 6 is a flowchart of a virtual object display method according to another embodiment of this application. In this embodiment, that the method is applied to the client introduced above is used as an example. The method may include the following operations (601 to 608):

Operation 601: Determine an interception plane of a three-dimensional model of a first virtual object.

The operation 601 is similar to or the same as the operation 301 in the embodiment shown in FIG. 3 above, which is not repeated herein.

Operation 602: Acquire posture information of the first virtual object at a first position in a virtual environment once after a preset time period, and determine posture information of the three-dimensional model based on a posture of the first virtual object at the first position.

A partial model of the first virtual object on a first side is displayed at a second position in the virtual environment. The first position and the second position are two different positions in the virtual environment. The partial model on the first side may refer to a partial model that is of the three-dimensional model of the first virtual object and that is arranged on a first side of an interception plane. The first position may refer to a current position of the first virtual object in the virtual environment, and the second position may be a designated position in the virtual environment. The designated position may be fixed or random. This is not limited in embodiments of this application.

In some embodiments, the first virtual object at the first position is controlled by a control operation of the user corresponding to the first virtual object. The first virtual object at the first position can interact substantially with the virtual environment (for example, another virtual object in the virtual environment), such as attacking the another virtual object, enduring attacks from the another virtual object, withstanding damage from the virtual environment, cutting down trees, opening or closing doors, and igniting flames. The partial model on the first side displayed at the second position may be seen as a projection of the three-dimensional model of the first virtual object at the first position, and therefore the posture of the partial model on the first side displayed at the second position is decided by the posture of the first virtual object at the first position, namely, the posture of the partial model on the first side displayed at the second position is the same as the posture of the corresponding partial model of the first virtual object at the first position.

The partial model on the first side is only configured to display a current state of the first virtual object, and the partial model on the first side displayed at the second position cannot interact substantially with the virtual environment. The another virtual object cannot cause substantial harm to the first virtual object by attacking the partial model on the first side displayed at the second position; and the partial model that is on the first side and is displayed at the second position cannot attack the another virtual object (the partial model on the first side displayed at the second position is actually not controlled by the user).

In some embodiments, both the first position and the second position are positions in the virtual environment. The first position may be any position in the virtual environment that the virtual object can actually reach; and the second position may be any position displayed in the virtual environment (namely, any position in the virtual environment that the user can see through the display interface). For example, the first position may be a ground surface, a hillside that the virtual object can climb, or a rooftop accessible to the virtual object by climbing stairs or a ladder. The second position may be located on a top of any building (for example, a rooftop inaccessible to the virtual object through user control), in the air, on the water surface, etc.

In some embodiments, the second position is a single position, namely, the partial model on the first side is only displayed at one position in the virtual environment. In some embodiments, the second position represents a plurality of positions, namely, the partial model on the first side can be simultaneously displayed at a plurality of positions in the virtual environment.

In some embodiments, the second position is a fixed position in the virtual environment, such as a position preset by related technical personnel according to actual situations. In some embodiments, the partial model on the first side of the first virtual object is only displayed near the virtual object. That is, for positions where there are no virtual objects nearby, the partial model on the first side is not displayed.

In some embodiments, the posture information includes position information of each mesh point on a surface of the three-dimensional model.

Operation 603: Determine a distance between each mesh point and the interception plane according to the position information of each mesh point.

In some embodiments, the surface of the three-dimensional model is composed of meshes (also known as patches, which may be triangular, quadrilateral, or other shapes), and vertexes of the meshes are called the mesh points. The position information of each mesh point refers to coordinates of each mesh point in the above rectangular plane coordinate system. Therefore, the distance between each mesh point and the interception plane can be calculated based on the coordinates of each mesh point. In some embodiments, the distance between the mesh point and the interception plane is a vector with a direction. If the distance between the mesh point and the interception plane is positive, the mesh point is located on the upper side of the interception plane; and if the distance between the mesh point and the interception plane is negative, the mesh point is located on the lower side of the interception plane.

For example, taking the interception plane being parallel to the horizontal plane of the virtual environment as an example, the interception plane is a plane z=1, and whether the distance between the mesh point and the interception plane is negative or positive can be determined based on a z value in the position information of the mesh point. If the z value is greater than 1, the distance is positive, and if the z value is less than 1, the distance is negative. In some embodiments, the z-value equal to 1 can be categorized into z-values greater than 1.

Operation 604: Select a mesh point whose distance meets a first condition to construct a partial model on the first side.

In some embodiments, the first side refers to the upper side of the interception plane, and therefore the first condition means that the distance to the interception plane is positive. Therefore, the partial model composed of mesh points with a positive distance to the interception plane can be determined as the partial model on the first side.

In some embodiments, the interception result further includes the partial model that is of the three-dimensional model and that is located on the second side of the interception plane, and the first side and the second side are respectively two sides of the interception plane. The mesh points with a negative distance to the interception plane are located on the lower side of the interception plane, namely, the partial model composed of the mesh points with the negative distance to the interception plane is the partial model on the second side.

Determining the interception result through the dense mesh points on the surface of the model can ensure, as much as possible, the smoothness of the interception plane obtained after intercepting the model.

Operation 605: Render the partial model on the first side, where the partial model on the second side is not rendered.

In some embodiments, the partial model on the first side is three-dimensional, and the partial model on the first side is mapped to a two-dimensional plane to be rendered; alternatively, the partial model on the first side is rendered and then mapped to the two-dimensional plane.

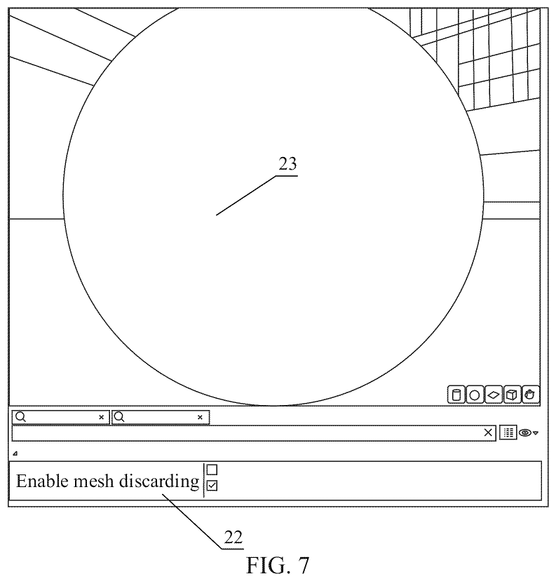

In some embodiments, the three-dimensional model is rendered based on a surface material of the three-dimensional model. In some embodiments, materials in the three-dimensional model are marked to obtain marked materials; and the material located on the partial model on the first side in the marked materials is rendered, where a material located on the partial model on the second side in the marked materials is not rendered. As shown in FIG. 7, by checking an enable mesh discard function control 22, part of or all of the materials corresponding to the three-dimensional model are marked, so that the material located on the second side in the partial model 23 in the marked materials is not rendered, thereby achieving a display effect that the partial model 23 on the second side is cut off. By selectively rendering the materials, the display of the partial model on the first side and the hiding of the partial model on the second side can be achieved, thereby reducing the rendering workload of the model and improving the naturalness of the display of the partial model on the first side.

In some embodiments, after operation 605, a rendered partial model on the first side may also be processed to obtain the processed partial model on the first side, making the display of the partial model on the first side more diverse. The processing includes at least one of the following: transparency processing, scaling processing, and blurring processing.

Operation 606: Display the rendered partial model on the first side.

In some embodiments, the processed partial model on the first side is displayed.

In some embodiments, a second position where the rendered partial model on the first side is located is fixed. After a display period is reached, by controlling the corresponding virtual object to be near the second position, the rendered partial model on the first side can only be displayed in the corresponding client of the user. For example, for an NPC in the virtual environment, when the virtual object controlled by a player moves to be near the second position, the partial model on the first side corresponding to the NPC is displayed at the second position. For another example, when another virtual object moves to be near the second position, the partial model on the first side corresponding to the first virtual object is displayed at the second position.

In some embodiments, the rendered partial model on the first side is displayed near all the virtual objects. By controlling the corresponding virtual object to search in the nearby virtual environment, the rendered partial model on the first side can be displayed in the corresponding client of the user.

Operation 607: Acquire achievement information of at least one first virtual object and at least one other virtual object in a same battle.

The achievement information refers to information corresponding to achievements obtained by the virtual objects during the battle. In some embodiments, the achievement information includes a number of virtual objects defeated or eliminated by the virtual object during the battle, duration of survival during the battle, etc.

In some embodiments, there may be one or more first virtual objects during a battle; and another virtual object refers to a virtual object other than the first virtual object during the battle. A user corresponding to the another virtual object can observe information, for example current equipment configuration, proficient or unproficient equipment and operations, and a position of the first virtual object through the displayed partial model on the first side of the first virtual object, thereby allowing the user corresponding to the another virtual object to better understand the operation level, current combat effectiveness, and the position of the user corresponding to the first virtual object. The user corresponding to the another virtual object has an informational advantage over the user corresponding to the first virtual object, which can reduce the achievements of the first virtual object during the battle (for example, reducing the number of virtual objects eliminated or defeated, and shortening the survival time during the battle) and enhance the achievements of the other virtual objects during the battle (for example, increasing the number of virtual objects eliminated or defeated, and prolonging the survival time during the battle).

In some embodiments, since the another virtual object can know the position of the first virtual object, the first virtual object may encounter more opponents (namely, the another virtual object during the battle), and accordingly, the first virtual object may defeat or eliminate more virtual objects. The another virtual object may also be defeated or eliminated earlier, or miss opportunities to defeat or eliminate other virtual objects other than the first virtual object in the process of actively seeking out and fighting with the first virtual object.

Operation 608: Adjust a display state of the three-dimensional model of the first virtual object based on the achievement information.

In some embodiments, after rendering the partial model on the first side, the client can also adjust the display state of the partial model on the first side based on the foregoing achievement information, which can further enhance the display comprehensiveness of the model information. The display state includes at least one of the following: information about the first virtual object correspondingly displayed during display of the interception result of the three-dimensional model, and display duration of the interception result of the three-dimensional model.

In some embodiments, the display duration of the interception result of the three-dimensional model may be 15 s, 30 s, 1 min, or 2 min. This is not specifically limited in embodiments of this application.

In some embodiments, the adjusting a display state of the three-dimensional model of the first virtual object based on the achievement information includes at least one of the following:

1. When an average battle achievement of the at least one first virtual object decreases by a first threshold, at least one of the information about the first virtual object correspondingly displayed during display of the interception result of the three-dimensional model, and the display duration of the interception result of the three-dimensional model is reduced.

2. When an average battle achievement of the at least one first virtual object increases by a second threshold, at least one of the information about the first virtual object correspondingly displayed during display of the interception result of the three-dimensional model, and the display duration of the interception result of the three-dimensional model is increased.

3. When an average battle achievement of the at least one other virtual object increases by a third threshold, at least one of the information about the first virtual object correspondingly displayed during display of the interception result of the three-dimensional model, and the display duration of the interception result of the three-dimensional model is reduced.

4. When an average battle achievement of the at least one other virtual object decreases by a fourth threshold, at least one of the information about the first virtual object correspondingly displayed during display of the interception result of the three-dimensional model, and the display duration of the interception result of the three-dimensional model is increased.

The average battle achievement can be obtained by averaging the achievement information of at least one virtual object. In some embodiments, a magnitude of change in the average battle achievement may refer to a magnitude of change in the current battle or a corresponding magnitude of change across all historical battles. The first threshold, the second threshold, the third threshold, and the fourth threshold may be set and adjusted according to actual usage requirements. This is not limited in embodiments of this application. By adjusting the display state of the three-dimensional model based on the achievement information, the display rationality of the model information can be improved.

In some embodiments, after the client displays the partial model on the first side, the display state of the partial model on the first side can be adjusted by acquiring and analyzing action postures of each virtual object and a corresponding frequency of each action posture. For example, if the action posture of the first virtual object is more exciting, the display duration of the partial model on the first side is increased.

In some embodiments, after the client displays the partial model on the first side, the display state of the partial model on the first side can be adjusted by acquiring and analyzing corresponding travel paths of each virtual object. For example, if the first virtual object lingers near the second position, the display duration of the partial model on the first side is increased.

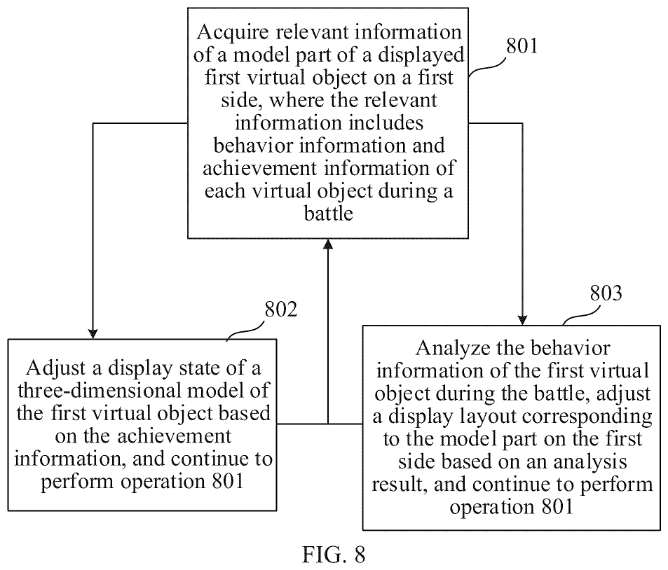

In some possible implementations, an embodiment of this application further provides an adjustment method. As shown in FIG. 8, the method includes the following operations:

Operation 801: Acquire relevant information of a partial model of a displayed first virtual object on a first side, where the relevant information includes behavior information and achievement information of each virtual object during a battle.

Operation 802: Adjust a display state of a three-dimensional model of the first virtual object based on the achievement information, and continue to perform operation 801.

Operation 803: Analyze the behavior information of the first virtual object during the battle, adjust a display layout corresponding to the partial model on the first side based on an analysis result, and continue to perform operation 801.

For example, based on the behavior information, it may be determined that the display of the partial model on the first side affects the control of the user on the first virtual object, and therefore the display layout of the partial model on the first side can be adjusted. The display layout may include a display size, a display position, display duration, etc. This content is described below, and is not repeated herein.

In summary, according to the technical solution provided in this embodiment of this application, the rationality of the display layout and the display duration of the partial model on the first side are determined based on the achievement information of the virtual objects and are adjusted, thereby ensuring, as much as possible, the rationality of the information about the first virtual object and the display duration of the interception result of the three-dimensional model correspondingly displayed during display of the interception result, improving the balance of the battle, and balancing fairness and fun during the battle.

In some possible implementations, the posture information includes pose information of each bone of the three-dimensional model. After operation 303, the method may further include the following sub-operations:

1. Determine a relative positional relationship between each bone and an interception plane based on the pose information of each bone.

In some embodiments, the three-dimensional model is a model constructed based on bones. The pose information of the bone includes a position and a posture of the bone. In some embodiments, the bone includes a bone vertex, and the position and the posture of the bone are determined by a position of the bone vertex.

In some embodiments, for each bone, if all the bone vertexes are located on the first side of the interception plane, it means that the bone is completely located on the first side of the interception plane; if all the bone vertexes are located on the second side of the interception plane, it means that the bone is completely located on the second side of the interception plane; and if some bone vertexes are located on the first side of the interception plane and some bone vertexes are located on the second side of the interception plane, it means that the bone intersects with the interception plane. For the process of determining which side of the interception plane the bone vertex is located on, reference may be made to the foregoing process of determining which side of the interception plane the mesh point of the three-dimensional model is located on, which is not repeated herein.

2. Select a bone whose relative positional relationship meets a second condition to construct a partial model on a first side.

In some embodiments, the second condition may be that all the bone vertexes are located on the first side of the interception plane, namely, the bone is completely located on the first side of the interception plane. The second condition may also be the existence of the bone vertexes located on the first side of the interception plane, namely, the bone is either completely located on the first side of the interception plane or intersects with the interception plane.

In some embodiments, a partial model corresponding to a bone completely located on the first side of the interception plane is determined as the partial model on the first side; alternatively, both the partial model corresponding to a bone completely located on the first side of the interception plane and a partial model corresponding to a bone intersecting with the interception plane are determined as the partial model on the first side.

In some embodiments, for a bone of the partial model located on the second side, the bone is hidden (not deleted), and as a result, a partial model corresponding to the hidden bone is not displayed, thereby achieving an intercepting effect.

In the foregoing implementation, the position of the bone is determined based on the bone vertexes, and the partial model on the first side that needs to be displayed is determined based on the position of the bone. Since a number of the bone vertexes is generally significantly less than a number of the mesh points on the surface of the three-dimensional model, the amount of computation required to determine the partial model on the first side is reduced, and processing resources are saved.

In some possible implementations, after operation 304, the method further includes:

1. Acquire behavior information of the first virtual object during the battle, where the behavior information includes control information, for the first virtual object, of a controller corresponding to the first virtual object and a corresponding control effect.

2. Analyze the behavior information of the first virtual object during the battle to obtain a behavior analysis result of the first virtual object during the battle, where the analysis result includes abnormal control information of the controller for the first virtual object.

3. Adjust a display layout corresponding to the partial model on the first side based on the abnormal control information.

In some embodiments, the controller corresponding to the first virtual object is a user corresponding to the first virtual object. The control information of the user may be reflected in a control effect on the virtual object. By analyzing the behavior information of the virtual object, the impact of the display of the partial model on the first side on user's control and the control effect may be obtained. If the display of the partial model on the first side negatively affects the user's control convenience and control effect, it may be determined that there is abnormal control information. Therefore, the display layout corresponding to the partial model on the first side may be adjusted to reduce or eliminate the negative impact of the current display layout of the partial model on the first side on user's control convenience and control effect.

For example, if a display area of the partial model on the first side is too large and obscures virtual controls (for example, a virtual joystick and a virtual shooting control), making it inconvenient for the user to quickly find the position of the virtual controls, the display area of the partial model on the first side may be reduced or the display duration of the partial model on the first side may be shortened.

For another example, if a size or color of the partial model on the first side is too similar to that of the virtual object actually controlled by the user, causing other users to consider it as the virtual object actually controlled by the user and perform operations such as attacking or defending on it, this will waste equipment resources, time, and energy of the other users, or expose the user position, the partial model on the first side may be made transparent, enlarged or reduced to a size significantly different from that of the virtual object actually controlled by the user, be marked, or undergo display position adjustment and other processing, to clearly distinguish the partial model on the first side from the virtual object actually controlled by the user, avoiding user confusion.

In the foregoing implementation, the display layout corresponding to the partial model on the first side is adjusted based on the behavior information of the virtual object, thereby avoiding or reducing the negative impact of the partial model on the first side on the user's control and control effect, ensuring the user's control convenience and the control experience, and improving the rationality of the display layout of the partial model on the first side.

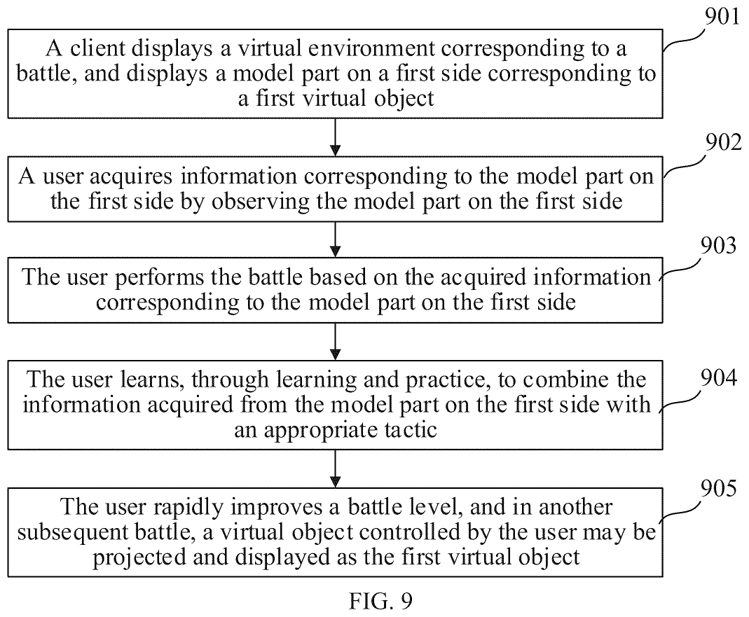

In some possible implementations, an embodiment of this application further provides a virtual object control method. As shown in FIG. 9, the method includes the following operations (901 to 905):

Operation 901: A client displays a virtual environment corresponding to a battle, and displays a partial model on a first side corresponding to a first virtual object.

The battle may refer to a game battle corresponding to a game application. The partial model on the first side is a key area (also known as a high-value area) of a three-dimensional model of the first virtual object.

Operation 902: The user acquires information corresponding to the partial model on the first side by observing the partial model on the first side.

The user can learn about operation information of the first virtual object by observing the partial model on the first side, and acquire information about the first virtual object (for example, position information).

Operation 903: The user performs the battle based on the acquired information corresponding to the partial model on the first side.

In some embodiments, after acquiring the aforementioned information, the user may either battle with the first virtual object or battle with other opponents other than the first virtual object based on information such as a learned operation mode.

Operation 904: The user learns, through learning and practice, to combine the information acquired from the partial model on the first side with appropriate tactics.

Operation 905: The user rapidly improves a battle level, and in subsequent other battles, the controlled virtual object may be projected and displayed as the first virtual object.

In the aforementioned implementation, the user learns the relevant operation skills and arranges appropriate tactics through the partial model on the first side of the displayed first virtual object, thereby facilitating the user to improve the control and battle levels, and then enhancing the fun of the battle.

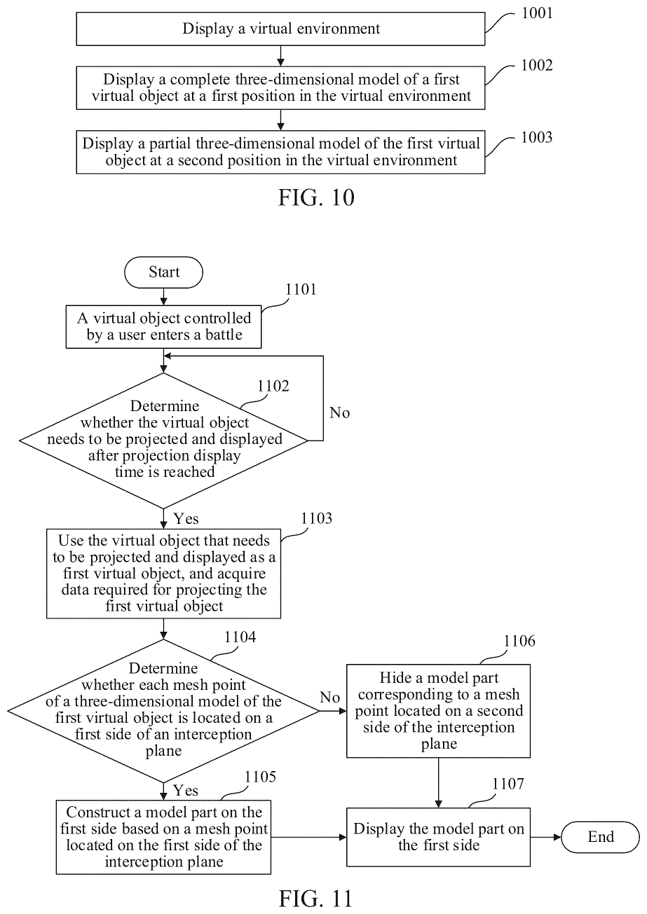

FIG. 10 is a flowchart of a virtual object display method according to another embodiment of this application. In this embodiment, that the method is applied to the client introduced above is used as an example. The method may include the following operations (1001 to 1003):

Operation 1001: Display a virtual environment.

Operation 1002: Display a complete three-dimensional model of a first virtual object at a first position in the virtual environment.

Operation 1003: Display a partial three-dimensional model of the first virtual object at a second position in the virtual environment.

The partial three-dimensional model is a partial model that is located on a first side of an interception plane and obtained by intercepting the complete three-dimensional model with the interception plane. The first position and the second position are different positions in the virtual environment.

In some embodiments, when the first virtual object performs a key battle operation, the client displays the partial three-dimensional model of the first virtual object at the second position in the virtual environment. The partial three-dimensional model is a partial model corresponding to the key battle operation, namely, by intercepting the partial model performing the key battle operation from the three-dimensional model with the interception plane, the partial three-dimensional model can be obtained. The key battle operation is an operation that changes the achievement information of the first virtual object during the battle, such as a battle operation of defeating an enemy virtual object.

For operation contents of operations 1001-1003, reference may be made to the foregoing embodiments, which are not repeated herein.

In summary, according to the technical solution provided in this embodiment of this application, the three-dimensional model of the first virtual object is intercepted by the interception plane, the interception result is displayed (namely, the partial model on the first side), and because the three-dimensional model is displayed after being intercepted and only the partial model on the first side of the interception plane is displayed, a more focused display of the model of the first virtual object can be achieved. The user only needs to acquire the information related to the first virtual object from the partial model on the first side without being affected by model parts useless for the user (for example, the user cannot obtain useful information from the model part), which helps the user rapidly and conveniently acquire the model information, improving the efficiency of acquiring the model information. In addition, displaying only a part of the three-dimensional model is beneficial to reduction of the display area occupied by the model, such that other areas in the interface can display more contents, thereby improving interface utilization.

In addition, when the first virtual object performs the key battle operation, the partial three-dimensional model of the first virtual object is displayed at the second position in the virtual environment, thereby prominently displaying the operation process of the first virtual object, facilitating other users to observe and learn the operation of the first virtual object, and then improving the efficiency of acquiring the model information.

In some possible implementations, referring to FIG. 11, the method may further include the following operations (1101 to 1107):

Operation 1101: A virtual object controlled by a user enters a battle.

Operation 1102: A client determines whether the virtual object needs to be projected and displayed after projection display time is reached, if so, perform operation 1103, and if not, continue to perform operation 1102.

In some embodiments, a set battle node or display time is the projection display time. After the projection display time is up, a projection of the virtual object is no longer displayed, namely, the partial model on the first side of the first virtual object is no longer displayed. In some embodiments, the projection display time may be 10 s, 45 s, 1 min, 2 min, etc. This is not specifically limited in embodiments of this application.

Operation 1103: The client uses the virtual object that needs to be projected and displayed as the first virtual object and acquires data required for projecting the first virtual object.

In some embodiments, the data required for projecting the first virtual object may be posture information and position information of a three-dimensional model of the first virtual object.

Operation 1104: The client determines whether each mesh point of the three-dimensional model of the first virtual object is located on a first side of the interception plane, if so, perform operation 1105, and if not, perform operation 1106.

Operation 1105: The client constructs the partial model on the first side based on a mesh point located on the first side of the interception plane, and performs operation 1107.

Operation 1106: The client hides a partial model corresponding to a mesh point located on a second side of the interception plane.

Operation 1107: The client displays the partial model on the first side.

For operation contents of operations 1101 to 1107, reference may be made to the foregoing embodiments, which are not repeated herein.

In summary, according to the technical solution provided in this embodiment of this application, by setting the projection display time, the projection of the first virtual object is only displayed with a limited small period, which avoids occlusion of other displayed contents (for example, elimination information and virtual controls) in the display interface due to the long-time display, improving the rationality of the model display.

The following describes apparatus embodiments of this application, which can be used for executing the method embodiments of this application. For details not disclosed in the apparatus embodiments of this application, refer to the method embodiments of this application.

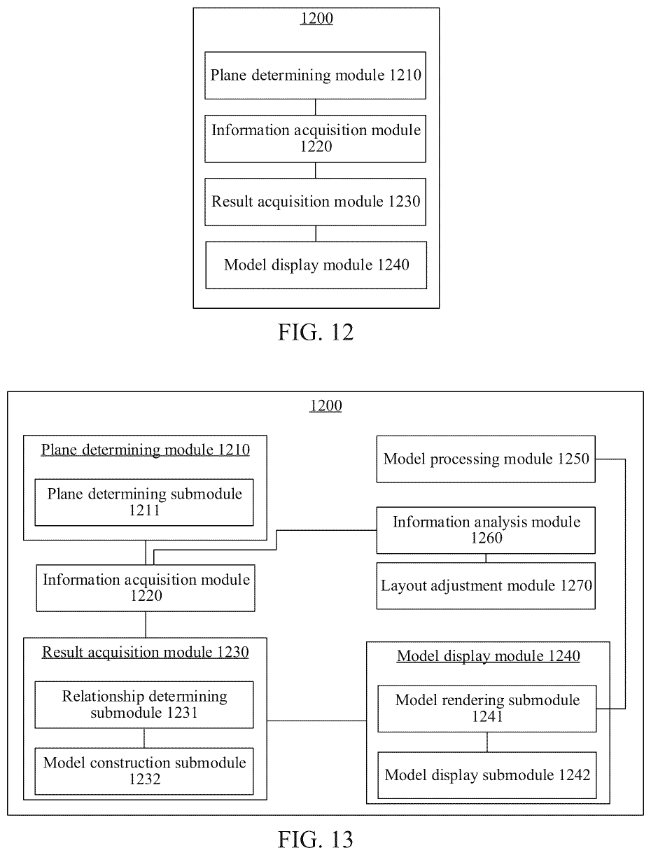

FIG. 12 is a block diagram of a virtual object display apparatus according to an embodiment of this application. The apparatus has a function of implementing the example of the above virtual object display method. The function may be implemented by hardware or may be implemented by the hardware executing corresponding software. The apparatus may be the terminal device introduced above, and or may be arranged on the terminal device. The apparatus 1200 may include: a plane determining module 1210, an information acquisition module 1220, a result acquisition module 1230, and a model display module 1240.

The plane determining module 1210 is configured to determine an interception plane of a three-dimensional model of a first virtual object.

The information acquisition module 1220 is configured to acquire posture information of the three-dimensional model once after a preset time period, where the posture information is configured for indicating a posture of the three-dimensional model.

The result acquisition module 1230 is configured to intercept, based on the posture information, the three-dimensional model by using the interception plane to obtain an interception result, where the interception result includes a partial model partial model of the three-dimensional model located on a first side of the interception plane, and the partial model on the first side changes with the posture of the three-dimensional model.

The model display module 1240 is configured to display the partial model on the first side.

In some embodiments, the posture information includes position information of each mesh point on a surface of the three-dimensional model. The result acquisition module 1230 is configured to:
determine a distance between each mesh point and the interception plane based on the position information of each mesh point; and
select mesh points with the distance meeting a first condition to construct the partial model on the first side.

In some embodiments, the posture information includes pose information of each bone of the three-dimensional model. As shown in FIG. 13, the result acquisition module 1230 includes: a relationship determining submodule 1231 and a model construction submodule 1232.

The relationship determining submodule 1231 is configured to determine a relative positional relationship between each bone and the interception plane based on the pose information of each bone.

The model construction submodule 1232 is configured to select a bone whose relative positional relationship meets a second condition to construct the partial model on the first side.

In some embodiments, as shown in FIG. 13, the model construction submodule 1232 is configured to:
determine, as the partial model on the first side, a partial model corresponding to a bone completely located on the first side of the interception plane; or
determine, as the partial model on the first side, both a partial model corresponding to a bone completely located on the first side of the interception plane and a partial model corresponding to a bone intersecting with the interception plane.

In some embodiments, the interception result further includes a partial model that is of the three-dimensional model and that is located on the second side of the interception plane, and the first side and the second side are respectively two sides of the interception plane. As shown in FIG. 13, the model display module 1240 includes: a model rendering submodule 1241 and a model display submodule 1242.

The model rendering submodule 1241 is configured to render the partial model on the first side, where the partial model on the second side is not rendered.

The model display submodule 1242 is configured to display a rendered partial model on the first side.

In some embodiments, as shown in FIG. 13, the model rendering submodule 1241 is configured to:
mark materials in the three-dimensional model to obtain marked materials; and
render a material located on the partial model on the first side in the marked materials, where a material located on the partial model on the second side in the marked materials is not rendered.

In some embodiments, as shown in FIG. 13, the apparatus 1200 further includes: a model processing module 1250.

The model processing module 1250 is configured to process the rendered partial model on the first side to obtain the processed partial model on the first side. The processing includes at least one of the following: transparency processing, scaling processing, and blurring processing.

The model rendering submodule 1241 is configured to display the processed partial model on the first side.

In some embodiments, the information acquisition module 1220 is further configured to acquire achievement information of at least one first virtual object and at least one other virtual object in a same battle; and the model display module 1240 is further configured to adjust a display state of the three-dimensional model of the first virtual object based on the achievement information, where the display state includes at least one of the following: information about the first virtual object correspondingly displayed during display of the interception result of the three-dimensional model, and display duration of the interception result of the three-dimensional model.

In some embodiments, the model display module 1240 is configured to:
reduce at least one of the information about the first virtual object correspondingly displayed during display of the interception result of the three-dimensional model, and the display duration of the interception result of the three-dimensional model when an average battle achievement of the at least one first virtual object decreases by a first threshold;
increase at least one of the information about the first virtual object correspondingly displayed during display of the interception result of the three-dimensional model, and the display duration of the interception result of the three-dimensional model when an average battle achievement of the at least one first virtual object increases by a second threshold;
reduce at least one of the information about the first virtual object correspondingly displayed during display of the interception result of the three-dimensional model, and the display duration of the interception result of the three-dimensional model when an average battle achievement of the at least one other virtual object increases by a third threshold;
or, increase at least one of the information about the first virtual object correspondingly displayed during display of the interception result of the three-dimensional model, and the display duration of the interception result of the three-dimensional model when an average battle achievement of the at least one other virtual object decreases by a fourth threshold.

In some embodiments, as shown in FIG. 13, the apparatus 1200 further includes: an information analysis module 1260 and a layout adjustment module 1270.

The information acquisition module 1220 is further configured to acquire behavior information of the first virtual object during the battle, where the behavior information includes control information, for the first virtual object, of a controller corresponding to the first virtual object and a corresponding control effect.

The information analysis module 1260 is configured to analyze the behavior information of the first virtual object during the battle to obtain a behavior analysis result of the first virtual object during the battle, where the analysis result includes abnormal control information of the controller for the first virtual object.

The layout adjustment module 1270 is configured to adjust, based on the abnormal control information, a display layout corresponding to the partial model on the first side.

In some embodiments, the information acquisition module 1220 is configured to:
acquire posture information of the first virtual object at a first position in a virtual environment once after a preset time period, and determine posture information of the three-dimensional model based on a posture of the first virtual object at the first position,
where the partial model on the first side is displayed at a second position in the virtual environment, and the first position and the second position are two different positions in the virtual environment.

In some embodiments, as shown in FIG. 13, the plane determining module 1210 includes: a plane determining submodule 1211.

The plane determining submodule 1211 is configured to determine the interception plane based on a battle situation of the first virtual object or the virtual environment where the first virtual object is located.

The plane determining submodule 1211 is further configured to determine an interception plane of the three-dimensional model of the first virtual object in response to an interception plane setting operation for the first virtual object.

In some embodiments, as shown in FIG. 13, the plane determining submodule 1211 is configured to:
when the first virtual object is under attack, adjust the interception plane to prominently display an attacked part of the first virtual object;
when the first virtual object performs an attack or defensive operation, adjust the interception plane to prominently display a part that is of the first virtual object and that performs the attack operation or the defensive operation;
or, determine the interception plane based on vegetation types, weather conditions, or terrains of the virtual environment.

In summary, according to the technical solution provided in this embodiment of this application, the three-dimensional model of the first virtual object is intercepted by the interception plane, the interception result is displayed (namely, the partial model on the first side), and because the three-dimensional model is displayed after being intercepted and only the partial model on the first side of the interception plane is displayed, a more focused display of the model of the first virtual object can be achieved. The user only needs to acquire the information related to the first virtual object from the partial model on the first side without being affected by model parts useless for the user (for example, the user cannot obtain useful information from the model part), which helps the user rapidly and conveniently acquire the model information, improving the efficiency of acquiring the model information. In addition, displaying only a part of the three-dimensional model is beneficial to reduction of the display area occupied by the model, such that other areas in the interface can display more contents, thereby improving the interface utilization.

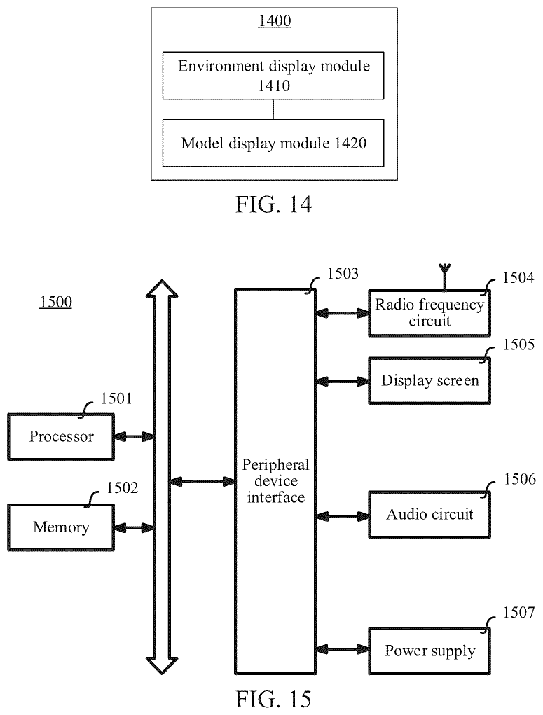

FIG. 14 is a block diagram of a virtual object display apparatus according to another embodiment of this application. The apparatus has a function of implementing the example of the above virtual object display method. The function may be implemented by hardware or may be implemented by the hardware executing corresponding software. The apparatus may be the terminal device introduced above, and or may be arranged on the terminal device. The apparatus 1400 may include: an environment display module 1410 and a model display module 1420.

The environment display module 1410 is configured to display a virtual environment.

The model display module 1420 is configured to display a complete three-dimensional model of the first virtual object at a first position in the virtual environment.

The model display module 1420 is further configured to display a partial three-dimensional model of the first virtual object at a second position in the virtual environment, where the partial three-dimensional model is a partial model that is located on a first side of an interception plane and that is obtained by intercepting the complete three-dimensional model by using the interception plane.

In some embodiments, the model display module 1420 is configured to display the partial three-dimensional model of the first virtual object at the second position in the virtual environment when the first virtual object performs a key battle operation, where the partial three-dimensional model is a partial model corresponding to the key battle operation, and the key battle operation is an operation that changes the achievement information of the first virtual object during the battle.

In summary, according to the technical solution provided in this embodiment of this application, the three-dimensional model of the first virtual object is intercepted by the interception plane, the interception result is displayed (namely, the partial model on the first side), and because the three-dimensional model is displayed after being intercepted and only the partial model on the first side of the interception plane is displayed, a more focused display of the model of the first virtual object can be achieved. The user only needs to acquire the information related to the first virtual object from the partial model on the first side without being affected by model parts useless for the user (for example, the user cannot obtain useful information from the model part), which helps the user rapidly and conveniently acquire the model information, improving the efficiency of acquiring the model information. In addition, displaying only a part of the three-dimensional model is beneficial to reduction of the display area occupied by the model, such that other areas in the interface can display more contents, thereby improving the interface utilization.

When the apparatus provided in the foregoing embodiments implements the functions of the apparatus, only division of the foregoing function modules is used as an example for description. In the practical application, the above functions may be allocated to and completed by different function modules according to requirements. That is, an internal structure of the device is divided into different function modules, to complete all or some of the functions described above. In addition, the apparatus provided in the foregoing embodiments and the method embodiments fall within a same conception. For details of a specific implementation process, refer to the method embodiments. Details are not described herein again.

In some embodiments, the embodiments of this application may further include the following content:

1. A virtual object display method, performed by a terminal device, and comprising:
determining an interception plane of a three-dimensional model of a first virtual object;
acquiring posture information of the three-dimensional model once after a preset time period, the posture information being configured for indicating a posture of the three-dimensional model;
intercepting, based on the posture information, the three-dimensional model by using the interception plane to obtain an interception result, wherein the interception result comprises a partial model of the three-dimensional model located on a first side of the interception plane, and the partial model on the first side changes with the posture of the three-dimensional model; and
displaying the partial model on the first side.

2. The method according to claim 1, wherein the posture information comprises position information of each mesh point on a surface of the three-dimensional model; and
the intercepting, based on the posture information, the three-dimensional model by using the interception plane to obtain an interception result comprises:
determining a distance between each mesh point and the interception plane based on the position information of each mesh point; and
selecting a mesh point whose distance meets a first condition to construct the partial model on the first side.

3. The method according to any one of claims 1 to 2, wherein the posture information comprises pose information of each bone of the three-dimensional model; and
the intercepting, based on the posture information, the three-dimensional model by using the interception plane to obtain an interception result comprises:
determining a relative positional relationship between each bone and the interception plane based on the pose information of each bone; and
selecting a bone whose relative positional relationship meets a second condition to construct the partial model on the first side.

4. The method according to claim 3, wherein the selecting a bone whose relative positional relationship meets a second condition to construct the partial model on the first side comprises:
determining, as the partial model on the first side, a partial model corresponding a bone completely located on the first side of the interception plane;
or,
determining, as the partial model on the first side, both a partial model corresponding to a bone completely located on the first side of the interception plane and a partial model corresponding to a bone intersecting with the interception plane.

5. The method according to any one of claims 1 to 4, wherein the interception result further comprises a partial model of the three-dimensional model located on a second side of the interception plane, and the first side and the second side are respectively two sides of the interception plane; and
the displaying the partial model on the first side comprises:
rendering the partial model on the first side, wherein the partial model on the second side is not rendered; and
displaying a rendered partial model on the first side.

6. The method according to claim 5, wherein the rendering the partial model on the first side comprises:
marking materials in the three-dimensional model to obtain marked materials; and
rendering a material located on the partial model on the first side in the marked materials,
wherein a material located on the partial model on the second side in the marked materials is not rendered.

7. The method according to any one of claims 5 to 6, wherein after the rendering the partial model on the first side, the method further comprises:
processing the rendered partial model on the first side to obtain the processed partial model on the first side, wherein the processing comprises at least one of the following: transparency processing, scaling processing, and blurring processing; and
the displaying a rendered partial model on the first side comprises:
displaying the processed partial model on the first side.

8. The method according to any one of claims 1 to 7, wherein after the displaying the partial model on the first side, the method further comprises:
acquiring achievement information of at least one first virtual object and at least one other virtual object in a same battle; and
adjusting a display state of the three-dimensional model of the first virtual object based on the achievement information, wherein the display state comprises at least one of the following: information about the first virtual object correspondingly displayed during display of the interception result of the three-dimensional model, and display duration of the interception result of the three-dimensional model.

9. The method according to claim 8, wherein the adjusting a display state of the three-dimensional model of the first virtual object based on the achievement information comprises:
reducing at least one of the information about the first virtual object correspondingly displayed during display of the interception result of the three-dimensional model, and the display duration of the interception result of the three-dimensional model when an average battle achievement of the at least one first virtual object decreases by a first threshold;
increasing at least one of the information about the first virtual object correspondingly displayed during display of the interception result of the three-dimensional model, and the display duration of the interception result of the three-dimensional model when an average battle achievement of the at least one first virtual object increases by a second threshold;
reducing at least one of the information about the first virtual object correspondingly displayed during display of the interception result of the three-dimensional model, and the display duration of the interception result of the three-dimensional model when an average battle achievement of the at least one other virtual object increases by a third threshold;
or,
increasing at least one of the information about the first virtual object correspondingly displayed during display of the interception result of the three-dimensional model, and the display duration of the interception result of the three-dimensional model when an average battle achievement of the at least one other virtual object decreases by a fourth threshold.

10. The method according to any one of claims 1 to 9, wherein after the displaying the partial model on the first side, the method further comprises:
acquiring behavior information of the first virtual object during a battle, the behavior information comprising control information, for the first virtual object, of a controller corresponding to the first virtual object and a corresponding control effect;
analyzing the behavior information of the first virtual object during the battle to obtain a behavior analysis result of the first virtual object during the battle, the analysis result comprising abnormal control information of the controller for the first virtual object; and
adjusting a display layout corresponding to the partial model on the first side based on the abnormal control information.

11. The method according to any one of claims 1 to 10, wherein the acquiring posture information of the three-dimensional model once after a preset time period comprises:
acquiring posture information of the first virtual object at a first position in a virtual environment once after a preset time period, and determining the posture information of the three-dimensional model based on a posture of the first virtual object at the first position,
wherein the partial model on the first side is displayed at a second position in the virtual environment, and the first position and the second position are two different positions in the virtual environment.

12. The method according to any one of claims 1 to 11, wherein the determining an interception plane of a three-dimensional model of a first virtual object comprises:
determining the interception plane based on a battle situation of the first virtual object or the virtual environment where the first virtual object is located;
or,
determining the interception plane of the three-dimensional model of the first virtual object in response to an interception plane setting operation for the first virtual object.

13. The method according to claim 12, wherein the determining the interception plane based on a battle situation of the first virtual object or the virtual environment where the first virtual object is located comprises:
when the first virtual object is under attack, adjusting the interception plane to prominently display an attacked part of the first virtual object;
when the first virtual object performs an attack or defensive operation, adjusting the interception plane to prominently display a part that is of the first virtual object and that performs the attack operation or the defensive operation;
or
determining the interception plane based on vegetation types, weather conditions, or terrains of the virtual environment.

14. A virtual object display method, performed by a terminal device, and comprising:
displaying a virtual environment;
displaying a complete three-dimensional model of a first virtual object at a first position in the virtual environment; and
displaying a partial three-dimensional model of the first virtual object at a second position in the virtual environment, wherein the partial three-dimensional model is a partial model located that is on a first side of an interception plane and that is obtained by intercepting the complete three-dimensional model by using the interception plane.

15. The method according to claim 14, wherein the virtual environment is a virtual environment where the first virtual object participates in a battle; and the displaying a partial three-dimensional model of the first virtual object at a second position in the virtual environment comprises:
displaying the partial three-dimensional model of the first virtual object at the second position in the virtual environment when the first virtual object performs a key battle operation, wherein the partial three-dimensional model is a partial model corresponding to the key battle operation, and the key battle operation is an operation that changes achievement information of the first virtual object during the battle.

In summary, according to the technical solution provided in this embodiment of this application, the three-dimensional model of the first virtual object is intercepted by the interception plane, the interception result is displayed (namely, the partial model on the first side), and because the three-dimensional model is displayed after being intercepted and only the partial model on the first side of the interception plane is displayed, a more focused display of the model of the first virtual object can be achieved. The user only needs to acquire the information related to the first virtual object from the partial model on the first side without being affected by model parts useless for the user (for example, the user cannot obtain useful information from the model part), which helps the user rapidly and conveniently acquire the model information, improving the efficiency of acquiring the model information. In addition, displaying only a part of the three-dimensional model is beneficial to reduction of the display area occupied by the model, such that other areas in the interface can display more contents, thereby improving the interface utilization.

FIG. 15 is a structural block diagram of a terminal device 1500 according to an embodiment of this application. The terminal device 1500 may be electronic devices, such as a phone, a tablet, a game console, an e-book reader, a multimedia player, a wearable device, and a PC. The terminal device is configured to implement the virtual object display method provided in the foregoing embodiments. The terminal device may be a terminal device 11 in the implementation environment shown in FIG. 1. Specifically,

typically, the terminal device 1500 includes: a processor 1501 and a memory 1502.

The processor 1501 may include one or more processing cores, for example, a 4-core processor and an 8-core processor. The processor 1501 may be implemented in at least one hardware form of digital signal processing (DSP), a field programmable gate array (FPGA), and a programmable logic array (PLA). The processor 1501 may also include a main processor and a coprocessor. The main processor is a processor configured to process data in an awake state, and is also referred to as a central processing unit (CPU). The coprocessor is a low power consumption processor configured to process data in a standby state. In some embodiments, the processor 1501 may be integrated with a graphics processing unit (GPU). The GPU is configured to render and draw content that needs to be displayed on a display screen. In some embodiments, the processor 1501 may further include an artificial intelligence (AI) processor. The AI processor is configured to process computing operations related to machine learning.

The memory 1502 may include one or more computer-readable storage media. The computer-readable storage medium may be non-transient. The memory 1502 may further include a high-speed random access memory and a nonvolatile memory, such as one or more disk storage devices or flash storage devices. In some embodiments, the non-transitory computer-readable storage medium in the memory 1502 is configured to store a computer program which is executed by one or more processors to implement the above virtual object display method.

In some embodiments, the terminal device 1500 further alternatively includes: a peripheral device interface 1503 and at least one peripheral device. The processor 1501, the memory 1502, and the peripheral device interface 1503 may be connected to one another through a bus or a signal cable. Each peripheral device may be connected to the peripheral device interface 1503 through a bus, a signal cable, or a circuit board. Specifically, the peripheral device includes: at least one of a radio frequency circuit 1504, a display screen 1505, an audio circuit 1506, and a power supply 1507.

Those skilled in the art may understand that the structure shown in FIG. 15 constitutes no limitation on the terminal device 1500, and the terminal device may include more or fewer components than those shown in the figure, or some components may be combined, or a different component deployment may be used.

In an exemplary embodiment, a computer-readable storage medium is further provided. The storage medium has a computer program stored therein. The computer program, when executed by a processor, implements in the above virtual object display method.

In some embodiments, the computer-readable storage medium may include: a read-only memory (ROM), a random-access memory (RAM), solid state drives (SSDs), or an optical disc, etc. The random access memory may include a resistance random access memory (ReRAM) and a dynamic random access memory (DRAM).

In an exemplary embodiment, a computer program product is further provided. The computer program product includes a computer program. The computer program is stored in a computer-readable storage medium. A processor of a computer device reads the computer program from the computer-readable storage medium, and the processor executes the computer program to enable the computer device to perform the above virtual object display method.

According to the embodiments of this application, before and during the process of collecting relevant data of the user, a prompt interface and a pop-up window may be displayed or voice prompt information may be outputted, and the prompt interface, the pop-up window, or the voice prompt information is configured to prompt the user that the relevant data thereof is currently being collected, such that the relevant operations in this application for acquiring the relevant data of the user are only performed after receiving a confirmation operation sent by the user for the prompt interface or the pop-up window. Or otherwise (namely, a confirmation operation sent by the user for the prompt interface or the pop-up window is not received), the relevant operations for acquiring the relevant data of the user are ended, namely, the relevant data of the user is not acquired. In other words, all user data collected in this application is strictly processed in accordance with relevant national laws and regulations. The collection of informed consent or separate consent of a personal information individual is carried out with the user agreement and authorization. Subsequent data use and processing activities are conducted within the scope authorized by laws, regulations, and the personal information individual. The collection, use, and processing of the relevant user data comply with the relevant laws, regulations, and standards of the relevant countries and regions. For example, the virtual objects, the virtual environments, achievement data, behavior data, and the like involved in this application are all acquired with full authorization.

“Plurality of” mentioned in the specification means two or more. “And/or” describes an association relationship of associated objects and represents that three relationships may exist. For example, A and/or B may represent: only A exists, both A and B exist, and only B exists. The character “/” generally indicates an “or” relationship between the preceding and succeeding associated objects.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A virtual object display method performed by a computer device, the method comprising:
determining an interception plane of a three-dimensional model of a first virtual object;
acquiring posture information of the three-dimensional model once after a preset time period;
intercepting the three-dimensional model by using the interception plane based on the posture information to obtain an interception result, wherein the interception result comprises a partial model of the three-dimensional model located on a first side of the interception plane; and
displaying the partial model on the first side.

2. The method according to claim 1, wherein the posture information comprises position information of each mesh point on a surface of the three-dimensional model; and
the intercepting the three-dimensional model by using the interception plane based on the posture information to obtain an interception result comprises:
determining a distance between each mesh point and the interception plane based on the position information of the mesh point; and
selecting a mesh point whose distance meets a first condition to construct the partial model on the first side.

3. The method according to claim 1, wherein the posture information comprises pose information of each bone of the three-dimensional model; and
the intercepting the three-dimensional model by using the interception plane based on the posture information to obtain an interception result comprises:
determining a relative positional relationship between each bone and the interception plane based on the pose information of the bone; and
selecting a bone whose relative positional relationship meets a second condition to construct the partial model on the first side.

4. The method according to claim 1, wherein the interception result further comprises a partial model of the three-dimensional model located on a second side of the interception plane, and the first side and the second side are respectively two sides of the interception plane; and
the displaying the partial model on the first side comprises:
rendering only the partial model on the first side; and
displaying the rendered partial model on the first side.

5. The method according to claim 1, wherein the method further comprises:
acquiring achievement information of at least one first virtual object and at least one other virtual object in a same battle; and
adjusting a display state of the three-dimensional model of the first virtual object based on the achievement information, wherein the display state comprises at least one of the following: information about the first virtual object correspondingly displayed during display of the interception result of the three-dimensional model, and display duration of the interception result of the three-dimensional model.

6. The method according to claim 1, wherein partial model the method further comprises:
acquiring behavior information of the first virtual object during a battle, the behavior information comprising control information, for the first virtual object, of a controller corresponding to the first virtual object and a corresponding control effect;
analyzing the behavior information of the first virtual object during the battle to obtain a behavior analysis result of the first virtual object during the battle, the analysis result comprising abnormal control information of the controller for the first virtual object; and
adjusting a display layout corresponding to the partial model on the first side based on the abnormal control information.

7. The method according to claim 1, wherein the acquiring posture information of the three-dimensional model once after a preset time period comprises:
acquiring posture information of the first virtual object at a first position in a virtual environment once after a preset time period, and determining the posture information of the three-dimensional model based on a posture of the first virtual object at the first position,
wherein the partial model on the first side is displayed at a second position in the virtual environment, and the first position and the second position are two different positions in the virtual environment.

8. The method according to claim 1, wherein the determining an interception plane of a three-dimensional model of a first virtual object comprises:
determining the interception plane based on a battle situation of the first virtual object or a virtual environment where the first virtual object is located.

9. A computer device, comprising a processor and a memory, wherein the memory has a computer program stored therein, and the computer program is loaded and executed by the processor to implement a virtual object display method including:
determining an interception plane of a three-dimensional model of a first virtual object;
acquiring posture information of the three-dimensional model once after a preset time period;
intercepting the three-dimensional model by using the interception plane based on the posture information to obtain an interception result, wherein the interception result comprises a partial model of the three-dimensional model located on a first side of the interception plane; and
displaying the partial model on the first side.

10. The computer device according to claim 9, wherein the posture information comprises position information of each mesh point on a surface of the three-dimensional model; and
the intercepting the three-dimensional model by using the interception plane based on the posture information to obtain an interception result comprises:
determining a distance between each mesh point and the interception plane based on the position information of the mesh point; and
selecting a mesh point whose distance meets a first condition to construct the partial model on the first side.

11. The computer device according to claim 9, wherein the posture information comprises pose information of each bone of the three-dimensional model; and
the intercepting the three-dimensional model by using the interception plane based on the posture information to obtain an interception result comprises:
determining a relative positional relationship between each bone and the interception plane based on the pose information of the bone; and
selecting a bone whose relative positional relationship meets a second condition to construct the partial model on the first side.

12. The computer device according to claim 9, wherein the interception result further comprises a partial model of the three-dimensional model located on a second side of the interception plane, and the first side and the second side are respectively two sides of the interception plane; and
the displaying the partial model on the first side comprises:
rendering only the partial model on the first side; and
displaying the rendered partial model on the first side.

13. The computer device according to claim 9, wherein the method further comprises:
acquiring achievement information of at least one first virtual object and at least one other virtual object in a same battle; and
adjusting a display state of the three-dimensional model of the first virtual object based on the achievement information, wherein the display state comprises at least one of the following: information about the first virtual object correspondingly displayed during display of the interception result of the three-dimensional model, and display duration of the interception result of the three-dimensional model.

14. The computer device according to claim 9, wherein the method further comprises:
acquiring behavior information of the first virtual object during a battle, the behavior information comprising control information, for the first virtual object, of a controller corresponding to the first virtual object and a corresponding control effect;
analyzing the behavior information of the first virtual object during the battle to obtain a behavior analysis result of the first virtual object during the battle, the analysis result comprising abnormal control information of the controller for the first virtual object; and
adjusting a display layout corresponding to the partial model on the first side based on the abnormal control information.

15. The computer device according to claim 9, wherein the acquiring posture information of the three-dimensional model once after a preset time period comprises:
acquiring posture information of the first virtual object at a first position in a virtual environment once after a preset time period, and determining the posture information of the three-dimensional model based on a posture of the first virtual object at the first position,
wherein the partial model on the first side is displayed at a second position in the virtual environment, and the first position and the second position are two different positions in the virtual environment.

16. The computer device according to claim 9, wherein the determining an interception plane of a three-dimensional model of a first virtual object comprises:
determining the interception plane based on a battle situation of the first virtual object or a virtual environment where the first virtual object is located.

17. A non-transitory computer-readable storage medium, having a computer program stored therein, wherein the computer program is loaded and executed by a processor of a computer device to implement a virtual object display method including:
determining an interception plane of a three-dimensional model of a first virtual object;
acquiring posture information of the three-dimensional model once after a preset time period;
intercepting the three-dimensional model by using the interception plane based on the posture information to obtain an interception result, wherein the interception result comprises a partial model of the three-dimensional model located on a first side of the interception plane; and
displaying the partial model on the first side.

18. The non-transitory computer-readable storage medium according to claim 17, wherein the method further comprises:
acquiring achievement information of at least one first virtual object and at least one other virtual object in a same battle; and
adjusting a display state of the three-dimensional model of the first virtual object based on the achievement information, wherein the display state comprises at least one of the following: information about the first virtual object correspondingly displayed during display of the interception result of the three-dimensional model, and display duration of the interception result of the three-dimensional model.

19. The non-transitory computer-readable storage medium according to claim 17, wherein the method further comprises:
acquiring behavior information of the first virtual object during a battle, the behavior information comprising control information, for the first virtual object, of a controller corresponding to the first virtual object and a corresponding control effect;
analyzing the behavior information of the first virtual object during the battle to obtain a behavior analysis result of the first virtual object during the battle, the analysis result comprising abnormal control information of the controller for the first virtual object; and
adjusting a display layout corresponding to the partial model on the first side based on the abnormal control information.

20. The non-transitory computer-readable storage medium according to claim 17, wherein the acquiring posture information of the three-dimensional model once after a preset time period comprises:
acquiring posture information of the first virtual object at a first position in a virtual environment once after a preset time period, and determining the posture information of the three-dimensional model based on a posture of the first virtual object at the first position,
wherein the partial model on the first side is displayed at a second position in the virtual environment, and the first position and the second position are two different positions in the virtual environment.
